(19) United States
(12) Patent Application Publication
(10) Pub. No.: US 2012/0255499 A1
(43) Pub. Date: Oct. 11, 2012

(54) EGG COLLECTOR

(75) Inventors: Yasushi Tsubai, Kakamigahara-shi (JP); Kazuhito Ban, Kakamigahara-shi (JP)

(73) Assignee: HYTEM CO., LTD., Kakamigahara-shi (JP)

(21) Appl. No.: 13/311,178

(22) Filed: Dec. 5, 2011

Related U.S. Application Data
(63) Continuation of application No. PCT/JP2011/058706, filed on Apr. 6, 2011.

(51) Int. Cl. A01K 45/00

(52) U.S. Cl. 119/337

(57) ABSTRACT

A roll out and conveyance unit of an egg collector includes endless conveyors which have orbit in the vertical direction on at least portions and are rotationally driven, rotary support portions which support rotation of the endless conveyors, a plurality of egg receiving portions which are attached to the endless conveyors at an equal interval and receive and hold eggs, and a roll out machinery portion which includes an initiation side roll out support portion and a termination side roll out support portion, and discharge plates which are provided so as to project from a termination side rotational shaft of the termination side roll out support portion, make contact with the egg which has been received by the egg receiving portion and has not been rolled out in the vicinity of the termination position to press the egg toward the cumulative egg collection conveyor.

This application is a continuation of International Application No. PCT/JP2011/058706 filed on Apr. 6, 2011.

### BACKGROUND OF THE INVENTION

### Field of the Invention

The present invention relates to an egg collector. In particular, the invention relates to an egg collector which is attached along a multi-tier poultry cage unit for hens in a poultry coop of a poultry housing and has a roll out and conveyance unit which conveys eggs transferred by an egg collection conveyor in a vertical direction, and rolls out the eggs to a cumulative egg collection conveyor.

An erected type multi-tier poultry cage unit for hens in which poultry cage units which can accommodate a number of hens are stacked at multi tires and are erected in a poultry coop is used. Various systems and mechanisms for automating a poultry raising operation and making the poultry raising operation efficient are attached along the multi-tier poultry cage unit for hens. For example, a feeding/water supply system which supplies food, water, nutritional supplement, and the like to hens in the poultry cage units under predetermined conditions, a feces removal system which removes excreted poultry feces from the poultry cage units to maintain a hygienic condition in the poultry coop, and the like are well known.

Further, in a poultry housing in which eggs are produced, an egg collection system (egg collector) which automatically collects eggs laid in the poultry cage unit at each stage is installed. The egg collector includes egg collection conveyors, control conveyors, a roll out and conveyance unit, and a cumulative egg collection conveyor. The egg collection conveyors are provided at lower positions of the poultry cage units and transfer eggs laid by hens toward one cage ends of the poultry cage units in a horizontal direction. The control conveyors receive the transferred eggs from the egg collection conveyors and transfer the eggs to the roll out and conveyance unit while aligning the eggs in a constant direction. The roll out and conveyance unit is provided to be erected along cage side surfaces of the multi-tier poultry cage unit for hens and has a plurality of egg receiving portions. The egg receiving portions receive the eggs from the control conveyors, convey the eggs in the vertical direction, and roll out the eggs on a predetermined roll out region. The cumulative egg collection conveyor accumulates the eggs collected from each poultry cage unit at one place.

An endless conveyor and the plurality of egg receiving portions are provided on the roll out and conveyance unit of the egg collector having the above configuration. The endless conveyor rotationally drives along the vertical direction. The plurality of egg receiving portions are arranged on the endless conveyor at an equal interval. However, there arises a trouble that the egg receiving portion which has received an egg holds the egg more than necessary, the egg is not rolled out normally on the predetermined roll out region, and the egg drops on a place other than the roll out region in some case (see, Japanese Patent Application Laid-open No. 2003-259754). In particular, when each egg receiving portion is configured to have one pair of bearing bars, if an egg to be received is smaller than a standard size and is trapped between the bearing bars, if an egg is broken during the conveyance and yolk and the like are adhered to surfaces of the bearing bars so that adherence thereof is increased, or if humidity in the poultry coop becomes higher, the above trouble occurs frequently. As a result, there arise a problem relating to hygienic conditions in the egg collector and the multi-tier poultry cage unit for hens so that a cleaning operation and a maintenance operation are made troublesome in some case.

On the other hand, the present inventors have enthusiastically studied an egg roll out mechanism of an egg collector and has already filed an application relating to an egg roll out mechanism in which the above problem is solved (see, International Patent Publication WO2007/113919). According to the technique, egg roll out cross bar assemblies are provided at positions just under eggs received on egg receiving means (egg receiving portions) each having a pair of bearing bars. A relative distance between the egg and each egg roll out cross bar assembly is changed in accordance with change of a transfer direction of the egg receiving means. Further, a bottom of the egg is pressed up by the egg roll out cross bar assembly by making the relative distance between the egg and the egg roll out cross bar assembly shortest on a roll out region. Then, the received state of the egg held by the egg receiving means more than necessary is released to assist the egg so as to be rolled out on the roll out region reliably. With this, the above trouble can be substantially eliminated.

However, in the case of the above egg roll out mechanism, a plurality of egg receiving means are installed and the same number of egg roll out cross bar assemblies are required to be provided for the egg receiving means. Therefore, in particular, in poultry farmers which produce eggs on a large scale, there has been a possibility that manufacturing cost of the egg collector itself is increased, and cleaning and maintenance operations are increased, resulting in increased burden on workers.

### SUMMARY OF THE INVENTION

In consideration of the above circumstances, an object of the invention is to provide an egg collector which can assist roll-out of an egg toward a cumulative egg collection conveyor on a roll out region and can save labors for cleaning and maintenance operations.

An egg collector according to an aspect of the invention which is attached along a multi-tier poultry cage unit for hens includes a roll out and conveyance unit which conveys eggs transferred from a plurality of poultry cage units in a vertical direction, and rolls out the eggs toward a cumulative egg collection conveyor on a predetermined roll out region. In the egg collector, the roll out and conveyance unit includes an endless conveyor which has an orbit along a cage side surface of the multi-tier poultry cage unit for hens in the vertical direction on at least a portion of the endless conveyor, a rotary support portion which supports rotation of the endless conveyor, a plurality of egg receiving portions which are attached to the endless conveyor at an equal interval and receive and hold the eggs, a roll out machinery portion which includes an initiation side roll out support portion provided at an initial position of the roll out region and a termination side roll out support portion provided at a termination position of the roll out region, and changes the orbit of the endless conveyor in the vertical direction to an oblique direction and inclines the egg receiving portions to roll out the eggs, and a discharge plate which is provided so as to project from a termination side rotational shaft of the termination side roll out support portion in a direction of a rotational shaft diameter, and makes contact with the egg which has been received by the egg receiving portion and has not been rolled out in the vicinity of the termination position to press the egg toward the cumulative egg collection conveyor with the rotation of the termination side rotational shaft.

Accordingly, with the egg collector according to the aspect of the invention, when there is an egg which is held by the egg receiving portion, which has reached to the vicinity of the termination end position of the roll out region, more than necessary due to some reason and is not rolled out, the discharge plate which rotates in conjunction of the termination side rotational shaft makes contact with the egg and a force in the direction toward the cumulative egg collection conveyor is applied to the egg. At this time, the egg receiving portion itself is obliquely inclined by change of the orbit of the endless conveyor by the roll out machinery portion and a received state of the egg is released by the above discharge plate so that roll-out toward the cumulative egg collection conveyor is assisted.

It is to be noted that the assistance for the roll-out of the egg is performed on the egg which remains on the egg receiving portion even in the vicinity of the termination position of the roll out region. Almost all the eggs are rolled out to the cumulative egg collection conveyor under the weight of the egg since the orbit of the endless conveyor is changed to the oblique direction by the roll out machinery portion.

Further, the endless conveyor configured as a chain assembly which is formed into a circular form by coupling the plurality of conveyor members having figures of eight to one another through connection members in a rotatable manner and connecting both ends thereof can be used. In addition, the rotary support portion for rotationally driving the endless conveyor such that the endless conveyer has an orbit in the vertical direction on at least a portion thereof can have a well-known configuration having a plurality of sprockets which mesh with the endless conveyor, a rotational shaft coupled to the sprockets, and the like. The roll out machinery portion which changes the orbit of the endless conveyor can be configured by combining a plurality of sprockets and rotational shafts in the same manner.

Further, in the egg collector according to the aspect of the invention, it is preferable that equal to or more than two discharge plates be provided at an equal interval so as to project about the termination side rotational shaft.

Accordingly, with the egg collector according to the aspect of the invention, equal to or more than two discharge places are provided on the termination side rotational shaft. For example, when two discharge plates are provided, an angle between the discharge plates is set to be 180° about a rotational shaft. When three discharge plates are provided, an angle between the discharge plates is set to be 120°. When two discharge plates are provided, the two discharge plates pass through the roll out region every time the termination side sprocket and the termination side rotational shaft rotates once. At this time, an installation interval between the egg receiving portions provided on the endless conveyor is adjusted to be set such that two egg receiving portions pass through the roll out region on the timing of the passage of the discharge plates so that the roll-out of eggs by the above discharge plates can be assisted continuously. If the number of discharge plates is increased and an interval between the egg receiving portions is made narrower, the number of assistances for roll-out of eggs per rotation of the roll out machinery portion can be increased. However, in such case, adjustment of passage timing becomes difficult. Therefore, it is particularly preferable that equal to or more than two and equal to or less than four discharge plates be provided.

With effects of the egg collector according to the aspect of the invention, roll-out of an egg toward a cumulative egg collection conveyor on a roll out region can be assisted and labors for cleaning and maintenance operations can be saved.

### BRIEF DESCRIPTION OF THE DRAWINGS

FIG. 1 is a descriptive view illustrating a schematic configuration of an egg collector according to an embodiment.

FIG. 2 is a perspective view illustrating a termination side roll out support portion and discharge plates.

FIG. 3 is a front view illustrating the termination side roll out support portion and the discharge plates.

FIG. 4 is a right side view illustrating the termination side roll out support portion and the discharge plates.

FIG. 5 is a descriptive view illustrating vicinity of a roll out region of the egg collector.

FIG. 6 is a perspective view illustrating the vicinity of the roll out region of the egg collector.

FIG. 7 is a descriptive view illustrating assistance for roll-out of an egg by a roll out and conveyance unit.

FIG. 8 is a descriptive view illustrating assistance for roll-out of an egg by the roll out and conveyance unit.

### DETAILED DESCRIPTION OF THE PREFERRED EMBODIMENTS

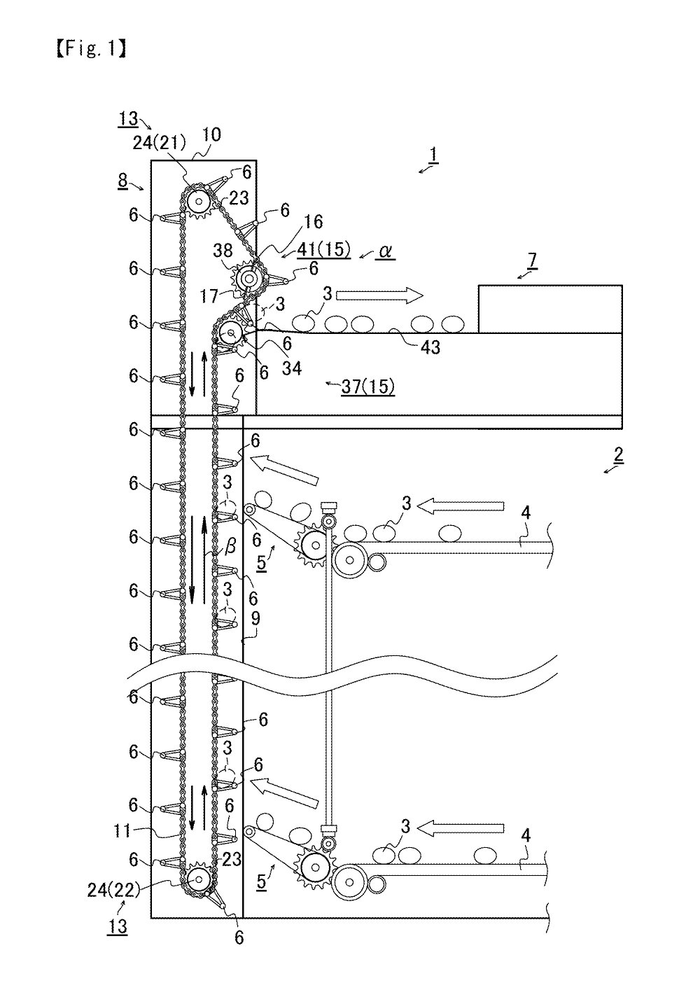

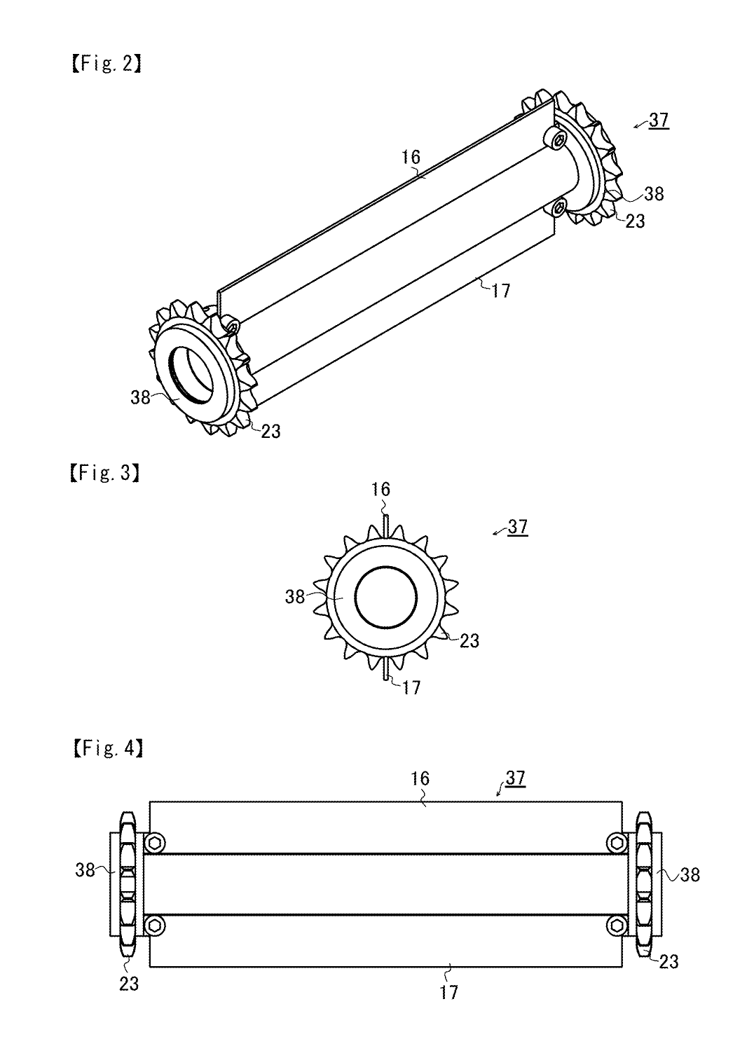

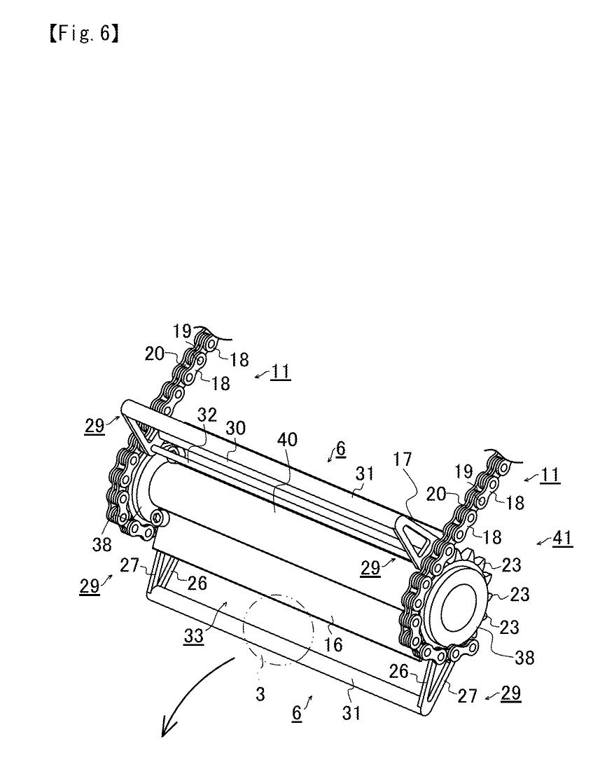

An egg collector 1 according to an embodiment of the invention is described with reference to FIG. 1 to FIG. 8. The egg collector 1 according to the embodiment as described here is attached along an erected type multi-tier poultry cage unit for hens 2 in which a plurality of poultry cage units which can accommodate a number of hens are stacked at multi tires and are erected in a poultry coop. In the plurality of poultry cage units, a number of hens are accommodated one by one such that a movable range of each hen is restricted. The egg collector mainly includes a plurality of egg collection conveyors 4, control conveyors 5, a roll out and conveyance unit 8, and a cumulative egg collection conveyor 7. The egg collection conveyors 4 are provided at lower positions of the poultry cage units at each tire and transfer eggs 3 toward one cage end of the multi-tier poultry cage unit for hens 2 in a horizontal direction. The control conveyors 5 align directions of the eggs 3 in a constant direction while transferring the eggs 3 transferred by the egg collection conveyors 4 in an obliquely upward direction. The roll out and conveyance unit 8 receives the eggs 3 delivered from the control conveyors 5 on egg receiving portions 6, conveys the eggs 3 in the vertical direction, and rolls out the eggs 3 toward the cumulative egg collection conveyor 7 on a predetermined roll out region a. The cumulative egg collection conveyor 7 collects and accumulates the rolled-out eggs 3.

An egg collection processing of a number of eggs 3 laid by hens in the poultry coop can be automated by employing the above configuration. Therefore, the eggs 3 accumulated in the cumulative egg collection conveyor 7 can be shipped to the market through a washing process and a selection process to be performed later. Since details of configurations of the egg collection conveyors 4, the control conveyors 5, and the cumulative egg collection conveyor 7 in the egg collector 1 according to the embodiment and functions thereof are already well known, description thereof will be omitted.

As illustrated in FIG. 1 to FIG. 8, the roll out and conveyance unit 8 in the roll out and conveyance unit 8 according to the embodiment includes a housing-like main body 10, a pair of circular endless conveyors 11, rotary support portions 13, the plurality of egg receiving portions 6, a roll out machinery portion 15, and a pair of discharge plates 16, 17. The main body 10 is provided so as to be erected along a cage side surface 9 of the multi-tier poultry cage unit for hens 2. The pair of endless conveyors 11 are accommodated in the main body 10, have β-orbit along the vertical direction on at least portions thereof, and are rotationally driven. The rotary support portions 13 support the endless conveyors 11 in a rotatable manner. The plurality of egg receiving portions 6 are installed between the pair of endless conveyors 11 and are attached to circular circumferences of the endless conveyors 11 at an equal interval. The roll out machinery portion 15 changes the β-orbit of the endless conveyors 11 in the vertical direction to γ-orbit in an oblique direction. The pair of discharge plates 16, 17 are provided on portions of the roll out machinery portion 15 and assists roll-out of the eggs 3.

The endless conveyors 11 are configured as chain assemblies which are formed into a circular form by coupling a plurality of conveyor members 18 having figures of eight to each other through connection members 19 in a rotatable manner and connecting both ends thereof. It is to be noted that mesh holes 20 are provided on side surfaces (corresponding to inner circumferential surfaces and outer circumferential surfaces of the circular endless conveyors 11) of the conveyor members 18. The mesh holes 20 mesh with sprockets 24 of the rotary support portions 13. Further, the rotary support portions 13 have upper rotary support portions 21 and lower rotary support portions 22 at upper positions and lower positions, respectively, which are lined on straight lines in the vertical direction of the roll out and conveyance unit 8. The upper rotary support portions 21 and lower rotary support portions 22 are portions for supporting the endless conveyors 11 in a rotatable manner.

The upper rotary support portions 21 and the lower rotary support portions 22 have pairs of sprockets 24, and bar-shaped rotational shafts (not illustrated) and are axially supported by the main body 10. A plurality of mesh projections 23 which can mesh with the mesh holes 20 of the endless conveyors 11 are provided on circumferences of the sprockets 24. The rotational shafts couple the pairs of sprockets 24. If rotation in a predetermined direction is applied to the rotational shafts in a state where the sprockets 24 are made to abut against the inner circumferential surfaces of the circular endless conveyors 11 and the mesh holes 20 and the mesh projections 23 are meshed with each other, the endless conveyors 11 can be rotationally driven at a constant speed. It is to be noted that a well-known driving means such as a motor for rotating the rotational shafts of the rotary support portions 13 are not illustrated in the embodiment. The endless conveyors 11 are configured to have the β-orbit along the vertical direction at positions corresponding to the egg collection conveyors 4 and the control conveyors 5 provided at lower positions of the poultry cage units at each tire.

On the other hand, the plurality of egg receiving portions 6 are attached along the circular circumferences of the pair of endless conveyors 11 at an equal interval. To be more specific, each egg receiving portion 6 includes a pair of side wall members 29, two bearing bars 30, 31, and a reinforced bar 32. The side wall members 29 have narrow side portions 25 which are attached to the conveyor members 18 constituting the pair of endless conveyors 11 and pairs of wide side portions 26, 27 which are extended from both ends of the narrow side portions 25 and of which front ends are coupled to each other. The side wall members 29 are formed into isosceles triangle shapes. The two bearing bars 30, 31 couple two vertices of the pair of side wall members 29 provided at corresponding positions of the pair of endless conveyors 11. The reinforced bar 32 couples remaining vertices of the side wall members 29. The reinforced bar 32 is a bar for reinforcing each egg receiving portion 6 such that the egg receiving portion 6 is not deformed in a state where the egg 3 is placed on the egg receiving portion 6. The reinforced bar 32 has a diameter smaller than those of the pair of bearing bars 30, 31.

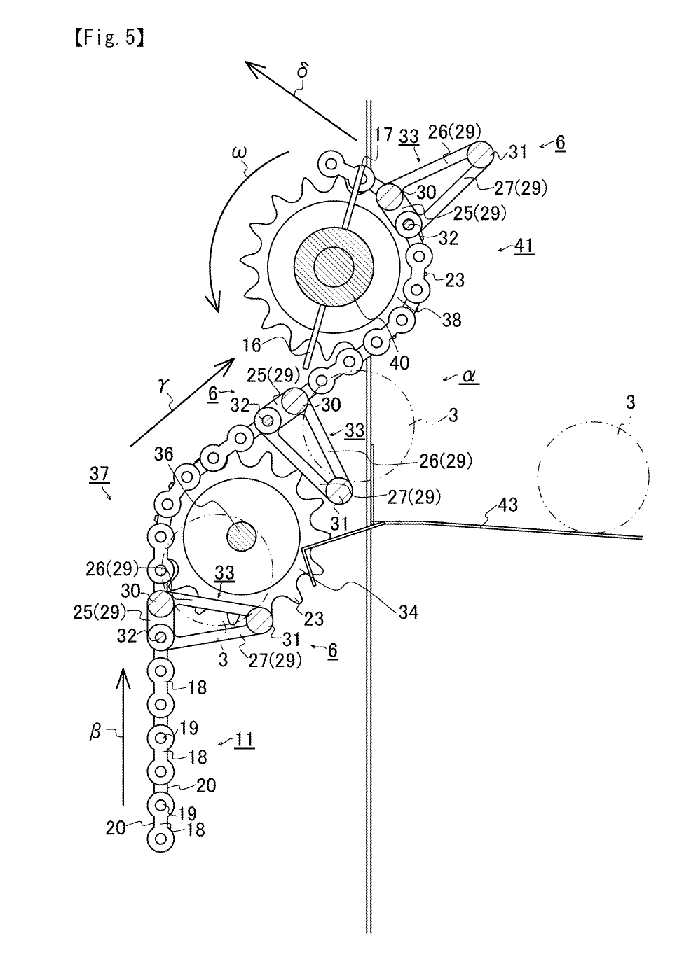

With this, a void 33 is formed between the pair of bearing bars 30, 31. If the egg 3 is received between the bearing bar 30 at the upper position of the narrow side portions 25 and the bearing bar 31 at the front end side of the wide side portions 26, 27, the egg 3 can be received and held by the egg receiving portion 6 in a state where a portion of a bottom of the egg 3 is protruded from the void 33. It is to be noted that the bearing bars 30, 31 and the reinforced bar 32 have bar lengths which are substantially the same as a conveyor width of each control conveyor 5. Therefore, a plurality of (for example, approximately two or three) eggs 3 can be received and held by one egg receiving portion 6 at the same time. As illustrated in FIG. 5 and the like, when the endless conveyors 11 are along the β-orbit in the vertical direction, the bearing bar 30 which makes closer to the endless conveyors 11 is located at a position slightly higher than the bearing bar 31 connecting the vertices at which the wide side portions 26, 27 are coupled. Further, the pair of bearing bars 30, 31 are formed with a plastic material having flexibility and moderate impact applied to the eggs 3 when the eggs 3 are delivered, conveyed, and rolled out so as to prevent the eggs 3 from being broken.

The roll out machinery portion 15 includes an initiation side roll out support portion 37 and a termination side roll out support portion 41. The initiation side roll out support portion 37 has a pair of initiation side sprockets 34 which abut against the outer circumferential surfaces of the endless conveyors 11 at an initiation position of the roll out α-region and an initiation side rotational shaft 36 which couples the initiation side sprockets 34. The termination side roll out support portion 41 has a pair of termination side sprockets 38 which abut against the inner circumferential surfaces of the endless conveyors 11 at a termination position of the roll out α-region and a termination side rotational shaft 40 which couples the termination side sprockets 38. The termination side roll out support portion 41 is provided at a position biased to the side of the cumulative egg collection conveyor 7 in the horizontal direction with respect to the β-orbit of the endless conveyors 11 in the vertical direction. Therefore, the β-orbit of the endless conveyors 11 in the vertical direction are changed to the γ-orbit. Further, the endless conveyors 11 are bent toward the upper rotary support portions 21 at the termination position so that the γ-orbit is changed to δ-orbit in the opposite oblique direction. A transfer plate 43 is provided at the initiation position of the roll out α-region. One end of the transfer plate 43 for guiding the eggs 3 rolled out by a normal roll-out operation to the cumulative egg collection conveyor 7 is bent so as to have a cross section of an L shape and is slightly inclined to the side of the cumulative egg collection conveyor 7. Further, the pair of discharge plates 16, 17 are provided on the termination side rotational shaft 40 of the termination side roll out support portion 41. The pair of discharge plates 16, 17 project in the direction of being separated from each other in the direction of the rotational shaft diameter and of which relative angle therebetween is set to 180°. The discharge plates 16, 17 are formed by plate-like members having plate widths which are substantially the same as the axial length of the termination side rotational shaft 40. Sixteen mesh projections 23 which can mesh with the mesh holes 20 of the endless conveyors 11 are provided on circular circumferences of the termination side sprockets 38. On the other hand, one egg receiving portion 6 is attached to the endless conveyors 11 every time eight conveyor members 18 are coupled. With this configuration, two egg receiving portions 6 pass through the roll out α-region every time the termination side sprockets 38 rotate once by rotational driving of the endless conveyors 11. Further, the pair of discharge plates 16, 17 rotate in a predetermined direction (see, an arrow ω in FIG. 5) with the rotation of the termination side sprockets 38 so as to pass through the roll out α-region on timing of the passage of the egg receiving portions 6.

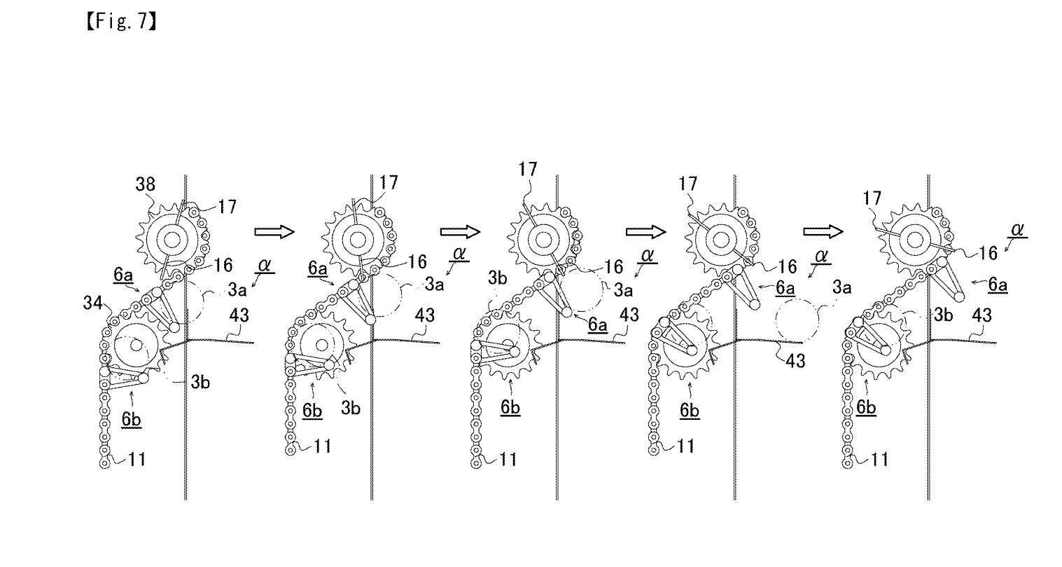

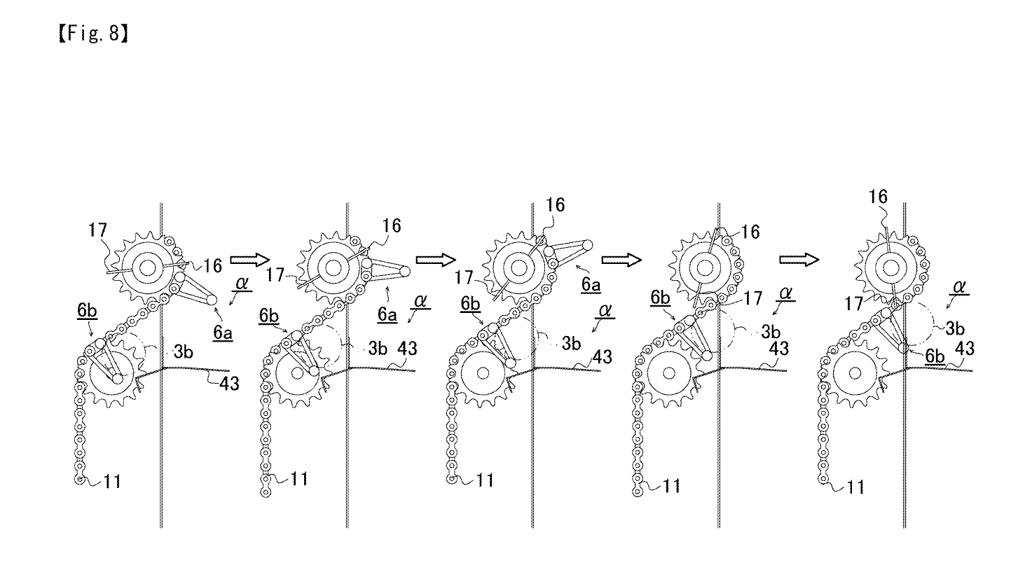

Next, flow of roll-out of the eggs 3 using the roll out and conveyance unit 8 in the egg collector 1 according to the embodiment is described mainly with reference to FIG. 7 and FIG. 8. FIG. 7 and FIG. 8 are views schematically illustrating the vicinity of the roll out α-region. FIG. 7 and FIG. 8 illustrate a state where the egg 3 is not normally rolled out from the egg receiving portion 6 and roll-out of the egg 3 held by the egg receiving portion 6 more than necessary is assisted. Further, in FIG. 7 and FIG. 8, time passes from left to right.

At first, the egg 3 conveyed to the upper side along the β-orbit in the vertical direction of the endless conveyors 11 reaches to an initial position of the rollout α-region. Here, orbit of the endless conveyors 11 change from the β-orbit in the vertical direction to the γ-orbit in the oblique direction by the roll out machinery portion 15. With this, the egg receiving portion 6 is also inclined with the change of the orbit of the endless conveyors 11 and the bearing bar 31 is located at a lower portion with respect to the bearing bar 30 at the side of the narrow side portions 25. Therefore, a received state of the egg 3 received and held between the pair of bearing bars 30, 31 is released under the weight of the egg 3 by the above inclination. Then, the egg 3 is rolled out to the cumulative egg collection conveyor 7 along the transfer plate 43. It is to be noted that as described above, when the endless conveyors 11 are along the β-orbit in the vertical direction, the bearing bar 30 which makes closer to the endless conveyors 11 is located at a position slightly higher than the bearing bar 31 connecting the vertices at which the wide side portions 26, 27 are coupled. Therefore, the egg receiving portion 6 is inclined on the roll out α-region so that the above roll-out is performed more easily. Accordingly, almost all the eggs 3 which have reached to the roll out α-region are rolled out in accordance with the above motion of each egg receiving portion 6.

Meanwhile, an egg 3a is held by an egg receiving portion 6a more than necessary due to some reason and the egg 3a is not rolled out only with the inclination of the egg receiving portion 6a in some case. In this case, the egg 3a goes toward the termination side roll out support portion 41 at the termination position of the roll out α-region in a state where the egg 3a is still placed on the inclined egg receiving portion 6a (see, left end drawing in FIG. 7). The egg 3a is made closer to the termination position of the roll out α-region in conjunction with the rotation of the termination side sprockets 38 and the termination side rotational shaft 40 (see, second drawing from left in FIG. 7).

Further, as the egg receiving portion 6a is made closer to the termination position, one discharge plate 16 makes contact with an upper portion of the egg 3a and a force of pressing the egg 3a to the side of the cumulative egg collection conveyor 7 in the horizontal direction is applied to the egg 3a (see, drawing at a center in FIG. 7). As a result, the force in the horizontal direction is applied to the egg 3a and the roll-out of the egg 3a is assisted so that a received state of the egg 3a is released (see, second drawing from right in FIG. 7). With this, the egg 3a which has not been rolled out is completed to be rolled out (see, right end drawing in FIG. 7). There is a possibility that the egg 3a drops toward the transfer plate 43 by the assistance for the roll-out from the termination position and receives an impact in comparison with a normal roll-out. However, a height from the termination position to the transfer plate 43 is slight so that there is substantially no risk that the egg 3a is broken due to the impact of the drop.

At this time, a subsequent egg receiving portion 6b by which a new egg 3b has been received reaches to the initial position of the roll out α-region. Here, the pair of discharge plates 16, 17 are provided on the termination side rotational shaft 40 according to the embodiment. Therefore, the other discharge plate 17 is located at the side opposite to the discharge plate 16 which has applied the force in the horizontal direction to the previous egg 3a and has assisted the roll-out. Accordingly, if the subsequent egg receiving portion 6b by which the new egg 3b has been received is conveyed toward the termination position (see, left end drawing, second drawing from left, drawing at a center, second drawing from right in FIG. 8), the other discharge plate 17 provided on the termination side rotational shaft 40 rotates in conjunction of the termination side sprockets 38 and the termination side rotational shaft 40 so as to make closer to the egg receiving portion 6b. As a result, the discharge plate 17 makes contact with the egg 3b received by the egg receiving portion 6b and applies a force in the horizontal direction to the side of the cumulative egg collection conveyor 7 so that the roll-out of the egg 3b is assisted (see, right end drawing in FIG. 8). With this configuration, two egg receiving portions 6 pass through the rollout α-region every time the termination side sprockets 38 rotate once. Further, even when a state where the eggs 3a, 3b are held on the egg receiving portions 6a, 6b, respectively, more than necessary continues, the roll-out of the eggs 3a, 3b can be assisted by the discharge plates 16, 17 continuously. Therefore, a trouble such as drop of the egg 3 on a place other than the roll out α-region can be prevented from occurring. It is to be noted that when the roll-out of the egg 3 is completed with a normal operation and the egg 3 is not placed on the egg receiving portion 6 closer to the termination position, the rotational ω-orbit of the rotating discharge plates 16, 17 do not interfere with the γ-orbit of the endless conveyors 11 in the oblique direction and the δ-orbit thereof in the opposite oblique direction so as not to hinder motions of them.

As described above, with the egg collector 1 according to the embodiment, if the pair of discharge plates 16, 17 provided on the termination side rotational shaft 40 of the termination side roll out support portion 41 rotate in conjunction with the termination side sprockets 38 of the endless conveyors 11, the egg 3 which has been received by the egg receiving portion 6 and has not been rolled out can be assisted to be rolled out. With this, a trouble that the egg 3 is rolled out from the egg receiving portion 6 or drops on a place other than the roll out α-region can be prevented from occurring. Therefore, a possibility that the egg collector 1 and the multi-tier poultry cage unit for hens 2 are contaminated by a broken egg 3 and the like is suppressed to be low. Further, the termination side roll out support portion 41 is provided at the termination position of the roll out α-region so that all the egg receiving portions 6 passing through the roll out α-region can be assisted to roll out the eggs 3. As a result, an action effect of the present application can be obtained by modifying the existing egg collector. This makes it possible to suppress facility cost from being increased. Further, the egg roll out cross bar assembly is not required to be provided on each egg receiving portion unlike the conventional egg collector. Therefore, operations of installation, cleaning, and the like can be simplified and shortened so that a large operation burden is not imposed.

As described above, the invention has been described with a preferred embodiment. However, the invention is not limited to the embodiment. Various modifications and changes in design can be made in a range without departing from a scope of the invention as follows.

That is to say, in the egg collector 1 according to the embodiment, the cumulative egg collection conveyor 7 is provided at the upper position of the multi-tier poultry cage unit for hens 2 and the eggs 3 are conveyed on the roll out α-region set at the upper position with respect to the poultry cage unit at the uppermost tier by the endless conveyors 11 of the roll out and conveyance unit 8. However, the invention is not limited thereto and the eggs 3 collected from each poultry cage unit may be conveyed to the lower side along the endless conveyors 11 and the eggs 3 may be rolled out on a roll out α-region provided at a lower position with respect to the poultry cage unit at the lowermost tier.

Further, in the egg collector 1 according to the embodiment, the pair of discharge plates 16, 17 are attached to the termination side rotational shaft 40 while a relative angle between the discharge plates 16, 17 is set to 180°. However, the invention is not limited thereto and the number of discharge plates can be appropriately changed. In this case, an interval between the egg receiving portions 6 attached to the endless conveyors 11 is adjusted in accordance with the rotation of the termination side rotational shaft 40 and a timing of assistance for roll-out of the eggs 3 needs to be adjusted.

What is claimed is:

1. An egg collector which is attached along a multi-tier poultry cage unit for hens, comprising,
a roll out and conveyance unit which conveys eggs transferred from a plurality of poultry cage units in a vertical direction, and rolls out the eggs toward a cumulative egg collection conveyor on a predetermined roll out region,
wherein the roll out and conveyance unit includes:
an endless conveyor which has an orbit along a cage side surface of the multi-tier poultry cage unit for hens in the vertical direction on at least a portion of the endless conveyor,
a rotary support portion which supports rotation of the endless conveyor,
a plurality of egg receiving portions which are attached to the endless conveyor at an equal interval and receive and hold the eggs;
a roll out machinery portion which includes an initiation side roll out support portion provided at an initial position of the roll out region and a termination side roll out support portion provided at a termination position of the roll out region, and changes the orbit of the endless conveyor in the vertical direction to an oblique direction and inclines the egg receiving portions to roll out the eggs, and
a discharge plate which is provided so as to project from a termination side rotational shaft of the termination side roll out support portion in a direction of a rotational shaft diameter, and makes contact with the egg which has been received by the egg receiving portion and has not been rolled out in the vicinity of the termination position to press the egg toward the cumulative egg collection conveyor with the rotation of the termination side rotational shaft.

2. The egg collector according to claim 1,
wherein equal to or more than two discharge plates are provided at an equal interval so as to project about the termination side rotational shaft.
